(19) United States
(12) Patent Application Publication
(10) Pub. No.: US 2018/0170510 A1
(43) Pub. Date: Jun. 21, 2018

(54) TUBE LAUNCHED HYBRID MULTIROTOR METHODS AND APPARATUS FOR SYSTEM

(71) Applicant: Raytheon Company, Waltham, MA (US)

(72) Inventor: Keith M. Brock, Vail, AZ (US)

(21) Appl. No.: 15/380,255

(22) Filed: Dec. 15, 2016

(51) Int. Cl. B64C 1/06; B64C 27/08; B64C 27/12; B64C 39/02

(52) U.S. Cl. CPC B64C 1/063; B64C 27/08; B64C 27/12; B64C 39/024; B64C 2201/165; B64C 2201/042; B64C 2201/108; B64C 2201/08; B64C 2201/027

(57) ABSTRACT

A launching system may include a multirotor platform that includes a plurality of motors and propellers. The multirotor platform may be launched from a launch tube and actuated to transition from a storage state to a flight state where the propellers are operable via the motors. The multirotor platform may include pivotable pivoting motor arms that are connected between the main flight body and the propellers. After the multirotor platform is deployed from the launch tube, the pivoting motor arms may be actuated to extend from a retracted position against the main flight body and enable operation of the motors and the propellers for powered flight of the multirotor platform. The multirotor platform may include motor pylon wings connected to the motors and retractable nose gears for deploying the motor pylon wings and enabling unpowered flight or gliding movement of the multirotor platform.

### FIELD OF THE INVENTION

The invention relates to a tube-launched multirotor platform having a system that enables the multirotor platform to transition directly into flight from a stored position.

### DESCRIPTION OF THE RELATED ART

Various applications may use unmanned air vehicles (UAVs), such as multirotor platforms. Examples of applications that may use UAVs include military applications, where the UAV may carry a lethal or nonlethal payload, or civil applications, where the UAV may perform surveillance-type functions. Still another application may be using the UAV in an aerial display, such as at an amusement park. UAVs may be used for many other different types of applications where having a human operator is not desirable. Generally, multirotor platforms are launched by a launching system that is arranged on a launching surface. Conventionally, the multirotor platform may be stored or carried within a container before the multirotor platform is set on a surface and throttled up for takeoff via the launching system. However, conventional launching systems may be limiting in that the multirotor platform may not be launched from the storage container to transition directly into flight, i.e. the multirotor platform may not be self-deploying or self-propelled. Using the conventional launching system may also prevent the platform from being suitable for certain applications, such as in an aircraft or other moving vehicle where it may be desirable to launch the multirotor platform into flight during flight or movement of the aircraft or vehicle.

### SUMMARY OF THE INVENTION

A multirotor platform, such as a quadcopter, may have a storage state and a flight state. The multirotor platform may include an energy source and a plurality of propellers and motors for driving the propellers. The multirotor platform may include a plurality of pivotable pivoting motor arms that are connected between the motors and the main flight body. The pivoting motor arms may be in a folded or retracted position within a launch tube during the storage state. After the multirotor platform has been launched out of the launch tube, the pivoting motor arms may be actuated to move to an unfolded position or extended position to transition the multirotor platform from the storage state to the flight state. Using the pivoting motor arms may enable the multirotor platform to transition directly from the storage state to a powered flight state. The pivoting motor arms may include wings or control surfaces that are actuated by mechanical, electric, or pneumatic methods. For example, the motor arms may use retractable nose gears. Using the wings and the retractable nose gears may enable the multirotor platform to transition directly from the storage state to unpowered gliding movement. Gas springs may also be used.

The following aspects of the invention may be combinable in any combination.

According to an aspect of the invention, a multirotor platform may have a storage state and a flight state. The multirotor platform may include a main flight body having an energy source and a plurality of propellers and motors for driving the propellers, where the motors are powered by the energy source and the propellers are moveable relative to the main flight body. The multirotor platform may include a plurality of pivoting motor arms that are connected between the propellers and the main flight body, where the pivoting motor arms are in a retracted position during the storage state and are moveable to an extended position when the multirotor platform transitions from the storage state to the flight state. The pivoting motor arms may extend along the main flight body when in the retracted position. The multirotor platform may include an actuator for pivoting the motor arms toward or away from the main flight body when moving to or from the retracted position.

According to an aspect of the invention, the pivoting motor arms may be symmetrically arranged about the main flight body.

According to an aspect of the invention, the main flight body may extend along a central axis, wherein during the storage state, the motor arms may extend in a direction that is parallel to the central axis, and wherein during the flight state, the motor arms may extend in a direction that is oblique or perpendicular to the central axis of the main flight body.

According to an aspect of the invention, each of the motor arms may include a cogged shaft having ends that are secured to the main flight body, where the cogged shaft may be rotatable about a central axis of the cogged shaft for pivoting the motor arms.

According to an aspect of the invention, each of the motor arms may include a cogged arm that is perpendicularly fixed to the cogged shaft, where the cogged arm is pivotable about the central axis.

According to an aspect of the invention, each of the motor arms may include a bolt arranged on the cogged shaft, where the bolt may be pivotable to rotate the cogged shaft and pivot the cogged arm.

According to an aspect of the invention, the multirotor platform may include a plurality of static tubes secured between the motor arms and the motors, wherein the motors may be moveable relative to the main flight body.

According to an aspect of the invention, the actuator may include a plurality of sources of compressed gas that are each associated with a corresponding one of the motor arms for pivoting the motor arms.

According to an aspect of the invention, the actuator may include a plurality of pre-loaded springs that are each connected to a corresponding one of the motor arms.

According to an aspect of the invention, the multirotor platform may be self-propelled for transitioning directly from the storage state to the flight state.

According to an aspect of the invention, the multirotor platform may include at least three motor arms.

According to an aspect of the invention, the multirotor platform may be a quadcopter having at least four motor arms.

According to an aspect of the invention, each of the motor arms may include a pylon and a nose gear for controlling the pylon after the pylon has moved to the extended position.

According to an aspect of the invention, the pylon may be a control surface for the multirotor platform and the multirotor platform may have unpowered gliding movement during the flight state.

According to an aspect of the invention, an unmanned aerial vehicle (UAV) launching system may include a launch tube having a longitudinal axis and a multirotor platform that is housed within the launch tube during a storage state and launched from the launch tube to transition to a flight state. The multirotor platform may include a main flight body having an energy source, a plurality of propellers and motors for driving the propellers, where the motors may be powered by the energy source and the propellers may be moveable relative to the main flight body, and a plurality of pivoting motor arms connected between the main flight body and the plurality of motors. The plurality of pivoting motor arms may be in a retracted position during the storage state and may be moveable from the retracted position to an extended position after the multirotor platform exits the launch tube. The propellers may be constrained from movement when the motor arms are in the retracted position. The UAV launching system may include at least one actuator for forcing the multirotor platform out of the launch tube and pivoting the motor arms, where the multirotor platform is in the flight state after the motor arms are actuated and the propellers are unconstrained from movement.

According to an aspect of the invention, the pivoting motor arms may be symmetrically arranged around the main flight body and wherein during the storage state, the pivoting motor arms may extend in a direction that is parallel to the longitudinal axis of the launch tube.

According to an aspect of the invention, the main flight body may extend along a central axis, and wherein during the flight state, the pivoting motor arms may extend in a direction that is oblique or perpendicular to the central axis of the main flight body.

According to an aspect of the invention, each of the pivoting motor arms may include a rotatable cogged shaft having ends that are secured to the main flight body, a cogged arm that is perpendicularly fixed to the cogged shaft, and a bolt arranged on the cogged shaft, wherein the bolt may be pivotable to rotate the cogged shaft and pivot the cogged arm about a rotation axis of the cogged shaft.

According to an aspect of the invention, the at least one actuator includes at least one of a source of compressed gas or an electrical actuator and a pre-loaded spring associated with each of the pivoting motor arms.

According to an aspect of the invention, a method for launching a multirotor platform may include storing the multirotor platform in a launch tube having a longitudinal axis, where the multirotor may include a main flight body having an energy source, a plurality of propellers, and a plurality of motors for driving the propellers, the motors being powered by the energy source. The method may further include folding a plurality of pivoting motor arms that are connected between the main flight body and the plurality of propellers against the main flight body, where the propellers are constrained from movement and the plurality of pivoting motor arms extend in a direction parallel to the longitudinal axis of the launch tube. The method may further include actuating the multirotor platform to force the multirotor platform out of the launch tube and actuating the plurality of pivoting motor arms to pivot outwardly from the main flight body and move the plurality of propellers to an unconstrained position. The method may still further include driving the plurality of propellers using the plurality of motors to fly the multirotor platform.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the invention.

FIG. 1 is a schematic drawing showing a top view of a multirotor platform in a storage state where the multirotor platform includes a pivotable motor arm.

FIG. 2 is a schematic drawing showing another elevated view of the multirotor platform in the storage state.

FIG. 3 is a schematic drawing showing a top view of the multirotor platform in a deployed state.

FIG. 4 is a schematic drawing showing a top view of the multirotor platform having a gas spring actuation device.

FIG. 5 is a schematic drawing showing a detailed view of a pivot bracket of the motor arm of FIG. 1.

FIG. 6 is a schematic drawing showing a detailed view of a toothed gear and arm of the motor arm of FIG. 1.

FIG. 7 is a schematic drawing showing the pivot bracket of FIG. 5 in engagement with the toothed gear of FIG. 6 to form the motor arm.

FIG. 8 is a schematic drawing showing a static tube connected between the motor arm and the motor of the multirotor platform of FIG. 1.

FIG. 9 is a schematic drawing showing a mounting bracket for mounting a motor to the static tube of FIG. 8.

FIG. 10 is a schematic drawing showing the multirotor platform of FIG. 1 in a storage position in a launch tube.

FIG. 11 is a schematic drawing showing a top view of the multirotor platform and launch tube of FIG. 10.

FIG. 12 is a schematic drawing showing a launch tube, and an actuator for launching the multirotor platform from the launch tube.

FIG. 13 is a schematic drawing showing a launching system for launching a multirotor platform from a launch tube located on the ground.

FIG. 14 is a schematic drawing showing a launching system for launching a multirotor platform from an aircraft.

FIG. 15 is a schematic drawing showing a secondary exemplary embodiment of a multirotor platform stored in a launch tube.

FIG. 16 is a schematic drawing showing the multirotor platform of FIG. 15 in a flight state.

FIG. 17A is a schematic drawing showing a nose gear for actuating a wing of the multirotor platform where the nose gear is in a retracted state.

FIG. 17B is a schematic drawing showing a nose gear for actuating a wing of the multirotor platform where the nose gear is in a retracted state.

FIG. 18A is a schematic drawing showing compressed air being released into a chamber of the launch tube for launching the multirotor platform.

FIG. 18B is a schematic drawing showing the compressed air bleeding through a leak hole into a reservoir of the launch tube.

FIG. 18C is a schematic drawing showing the reservoir of the launch tube being pressurized such that the launching system is in equilibrium.

FIG. 18D is a schematic drawing showing a dump valve being opened to cause an unbalanced pressure distribution through the launch tube.

FIG. 18E is a schematic drawing showing pressure being exerted against a piston.

FIG. 18F is a schematic drawing showing pressure being dumped into the launch tube to force the multirotor platform out of the launch tube.

### DETAILED DESCRIPTION

The principles described herein may be suitable for any application implementing an unmanned air vehicle (UAV) or a drone-type vehicle. An example of a suitable application may be a defense application such as an air-based mission, land-based mission, sea-based mission, or any combination thereof. The launching system described herein may be implemented in any suitable stationary platform or mobile platform including air, land, or sea vehicles. Examples of suitable vehicles may include naval ships, cars, tanks, armored personnel carriers, hovercraft, helicopters, and planes. Still other examples include a single tube launcher or a battery of tubes. Many other vehicles may be suitable. More specifically, a multirotor platform as described herein may be stored in a launch tube located on a mobile platform, launched from the launch tube during movement of the mobile platform, and transition directly into a flight state. The multirotor platform may include a plurality of deployable pivoting motor arms that act as control surfaces of the multirotor platform and enable self-propulsion of the multirotor platform out of the launch tube and into the flight state.

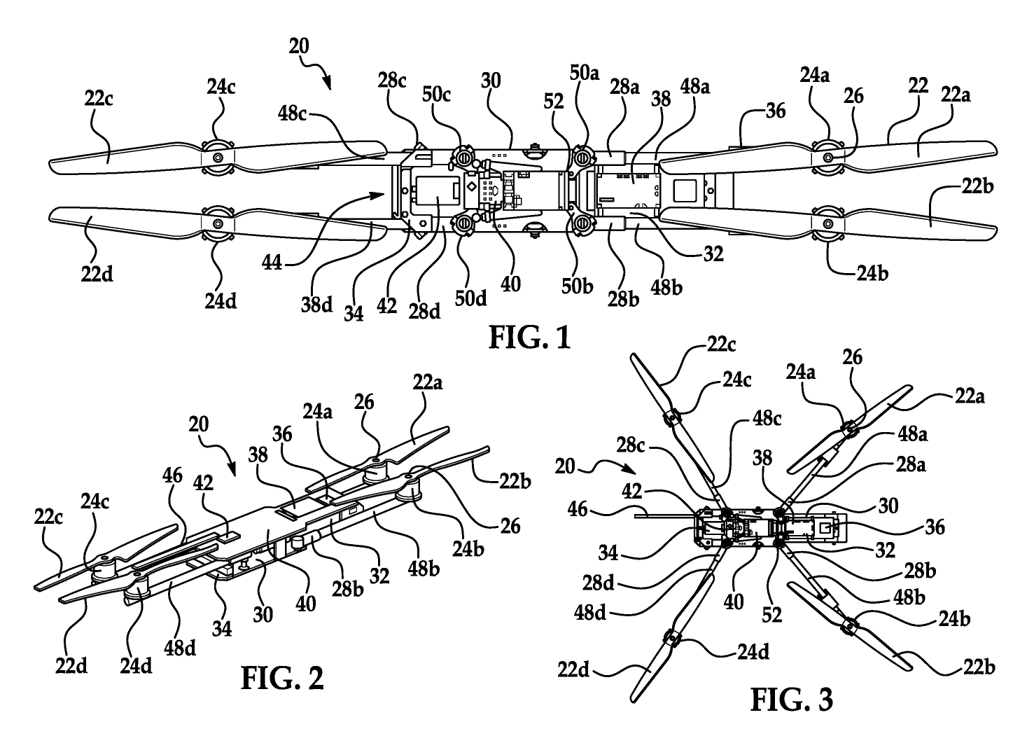

Referring now to FIGS. 1-3, a multirotor platform 20 is shown. The multirotor platform 20 may be a UAV or a drone-type vehicle. The multirotor platform 20 may include at least one rotor or vertically-oriented propeller 22 that may be rotatable during flight of the multirotor platform 20. The multirotor platform 20 may include a plurality of propellers 22a, 22b, 22c, 22d. The multirotor platform 20 may include at least three propellers. The multirotor platform 20 may be a tricopter or a quadcopter having four propellers 22a, 22b, 22c, 22d, as shown in FIGS. 1-3. The multirotor platform 20 may include more than four propellers. The multirotor platform 20 may include a plurality of electric motors 24a, 24b, 24c, 24d, where each of the electric motors 24a, 24b, 24c, 24d drives a corresponding one of the plurality of propellers 22a, 22b, 22c, 22d. Any suitable number of motors may be used and any suitable motor may be used, such as a brushless outrunner motor. As shown with regards to a first propeller 22a and a first motor 24a, a central portion 26 of the propeller 22a may be mounted to the motor 24a and the propeller 22 may be rotatable about the central portion 26. Each of the propellers 22a, 22b, 22c, 22d may be mounted similarly to the corresponding motor 24a, 24b, 24c, 24d such that the multirotor platform 20 may have a plurality of rotatable propellers 22a, 22b, 22c, 22d during the flight state.

The multirotor platform 20 may include a plurality of pivotable pivoting motor arms 28a, 28b, 28c, 28d that are connected between the plurality of motors 24a, 24b, 24c, 24d and a main flight body 30 of the multirotor platform 20. The plurality of motor arms 28a, 28b, 28c, 28d are shown as being connected between the main flight body 30 and the plurality of motors 24a, 24b, 24c, 24d, but in another embodiment, the motor arms 28a, 28b, 28c, 28d may be connected between the main flight body 30 and the propellers 22a, 22b, 22c, 22d, and the motors 24a, 24b, 24c, 24d may be arranged on the main flight body 30 and connected to the propellers 22a, 22b, 22c, 22d via a cable or any other suitable attachment means. The main flight body 30 may include an energy source, such as a battery 32. For example, the main battery 32 may be a lithium-ion battery. Any other suitable energy source may be used, such as solar cells, hydro fuel cells, combustion engines, or laser transmitters. The main flight body 30 may be configured to perform a plurality of different functions such as surveillance and target detection. The main flight body 30 may include suitable components such as a data link system 34, a global positioning system 36, a surveillance system 38, a control system 40, a processor 42, or a sensor 44 for performing any suitable function of the main flight body. The main flight body 30 may include an antenna 46. The aforementioned components may be combinable in any configuration of the main flight body 30 and the main flight body 30 may include any other suitable components used for operation of a UAV or drone.

The pivoting motor arms 28a, 28b, 28c, 28d of the multirotor platform 20 may be pivotable between a first position, shown in FIGS. 1 and 2, and a second position, shown in FIG. 3. The first position of the pivoting motor arms 28a, 28b, 28c, 28d may correspond to a storage or stowed position of the multirotor platform 20, when the multirotor platform 20 is stored in a launch tube and initially launched out of the launch tube, before the multirotor platform 20 is actuated for flight. The main flight body 30 may have any suitable shape. For example, the main flight body 30 may be rectangular in shape such that the pivoting motor arms 28a, 28b, 28c, 28d extend in a direction along a length of the main flight body 30. When in the first position, the pivoting motor arms 28a, 28b, 28c, 28d may extend in a direction that is parallel to a longitudinal axis, or central axis, of the main flight body 30 such that the pivoting motor arms 28a, 28b, 28c, 28d are aligned with the length of the main flight body 30. At least four pivoting motor arms may be used. More than four pivoting motor arms may be used. Two of the pivoting motor arms 28a, 28b may extend in a first direction and two of the pivoting motor arms 28b, 28c may extend in a second direction opposite the first direction. When in the second position, the pivoting motor arms 28a, 28b, 28c, 28d may pivot away from the main flight body 30 and project outwardly from the main flight body 30. When in the second position, each of the pivoting motor arms 28a, 28b, 28c, 28d may extend in a direction that is oblique or perpendicular to the central axis of the main flight body 30, as shown in FIG. 3.

Each of the pivoting motor arms 28a, 28b, 28c, 28d may receive a static tube 48a, 48b, 48c, 48d that is connected between the motor arm and the corresponding propeller 22. The static tubes 48a, 48b, 48c, 48d may be formed of stainless steel and the static tubes 48a, 48b, 48c, 48d may be fixed for movement with the pivoting motor arms 28a, 28b, 28c, 28d. The static tubes 48a, 48b, 48c, 48d may project from the main flight body 30 during flight of the multirotor platform 20. When the pivoting motor arms 28a, 28b, 28c, 28d are in the first position, the static tubes 48a, 48b, 48c, 48d may extend in a direction that is parallel to the longitudinal axis of the main flight body 30 and along the main flight body 30. The propellers 22a, 22b, 22c, 22d and the pivoting motor arms 22a, 22b, 22c, 22d may extend in the same direction as the corresponding one of the static tubes 48a, 48b, 48c, 48d. The overall length of the multirotor platform 20, defined between the furthest extending ends of the propellers 22a, 22b, 22c, 22d, may be greater when the pivoting motor arms 28a, 28b, 28c, 28d are in the first position and the multirotor platform 20 is in the stowed position, as compared with the second position of the pivoting motor arms 28a, 28b, 28c, 28d. When the pivoting motor arms 28a, 28b, 28c, 28d pivot outwardly from the main flight body 30 to move from the first position to the second position, the overall width of the multirotor platform 20, defined between the furthest extending ends of the propellers 22a, 22b, 22c, 22d, may be greater as compared with the first position of the pivoting motor arms 28a, 28b, 28c, 28d. When the pivoting motor arms 28a, 28b, 28c, 28d are in the first position, the propellers 22a, 22b, 22c, 22d may be constrained from rotation. When the pivoting motor arms 28a, 28b, 28c, 28d are in the second position, the propellers 22a, 22b, 22c, 22d may freely rotate. Using the pivoting motor arms 28a, 28b, 28c, 28d may be advantageous in that the multirotor platform 20 may have a stowed position that accommodates less space as compared with the space accommodated by the multirotor platform 20 during flight, due to the propellers 22a, 22b, 22c, 22d being constrained from rotation.

As best shown in FIG. 1, each of the pivoting motor arms 28a, 28b, 28c, 28d may include a pivot bracket 50a, 50b, 50c, 50d that is connected to the main flight body 30. In an exemplary embodiment, a distance between the central portion 26 of the propeller 22 and the pivot bracket 50a, 50b, 50c, 50d may be between 28 and 32 centimeters. As shown with regards to a first pivot bracket 50a, each of the pivot brackets 50a, 50b, 50c, 50d may be connected to an actuation device 52 for actuating the corresponding one of the pivot bracket 50a, 50b, 50c, 50d and forcing the corresponding motor arm 28a, 28b, 28c, 28d to pivot outwardly from the main flight body 30. The multirotor platform 20 may include a plurality of actuation devices where each actuation device corresponds to one of the pivoting motor arms 28a, 28b, 28c, 28d. The actuation device 52 may be contained within the main flight body 30 and may include any suitable type of actuation. The actuation device 52 may be configured for electrical, mechanical or pneumatic actuation. The actuation device 52 may be a hydraulic device, such as a piston.

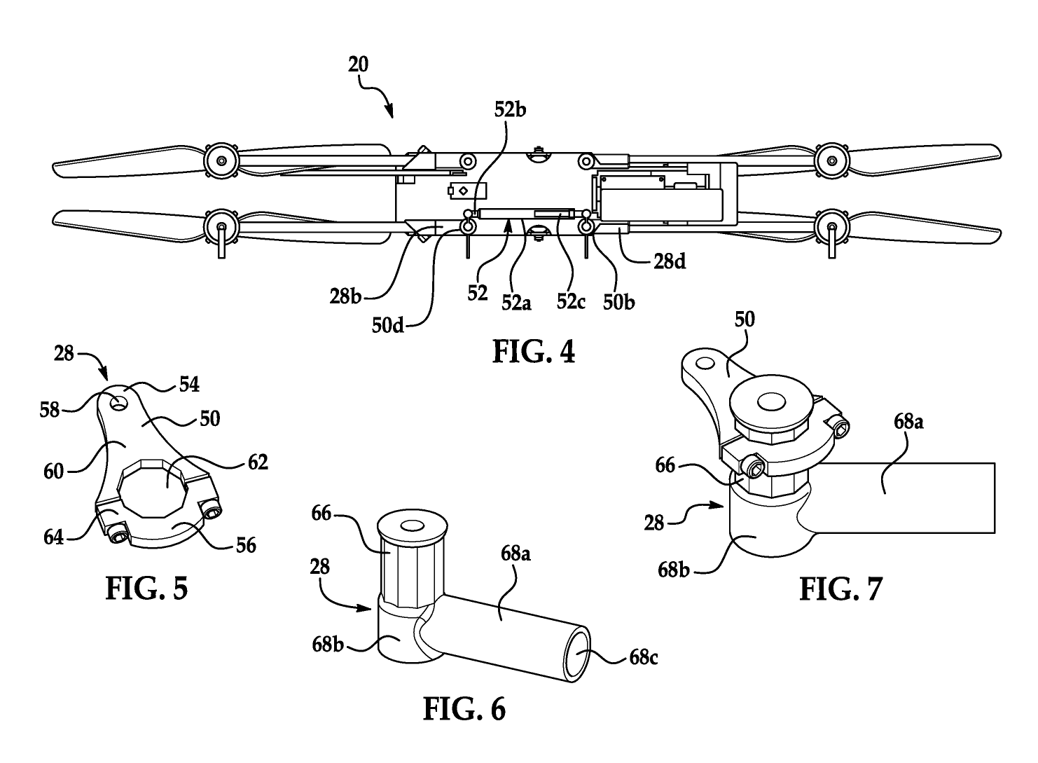

Referring now to FIG. 4, an exemplary actuation device 52 for the pivoting motor arms 28b, 28d of the multirotor platform 20 may be a gas spring 52a that extends between the pivot brackets 50b and 50d of the pivoting motor arms 28b, 28d. The gas spring 52a may include a displaceable piston rod 52b and a nose bearing 52c. The piston rod 52b may be axially compressed and extended for pivoting the pivot brackets 50b, 50d and the associated pivoting motor arms 28b, 28d. The gas spring 52a may have a force range between about 0.90 kilograms (about 2 pounds) and 16 kilograms (about 34 pounds). The gas spring 52a may have a stroke range between 2.54 centimeters (around 1 inch) and 8.90 centimeters (around 3.5 inches). The gas spring 52a may be configured for around 250,000 cycles and may be operable for extreme temperature ranges. The aforementioned features of the gas spring are merely examples and many alternative configurations and features may be suitable.

Referring now to FIGS. 5-9, features of the motor arm 28 are shown in detail. The pivot bracket 50 of the motor arm 28 is shown in detail in FIG. 5. The pivot bracket 50 may be formed of nylon and may extend from a first end 54 to a second end 56. The first end 54 of the pivot bracket 50 may be attached to the actuation device and may be generally cylindrical. The first end 54 may define a pin hole 58 having a pivot axis about which the pivot bracket 50 may pivot when actuated by the actuation device. The pivot bracket 50 may have a main body 60 that has an increasing area from the first end 54 toward the second end 56. The second end 56 may define a bolt-receiving aperture 62 that has a larger diameter as compared with the diameter of the pin hole 58 at the first end 54. The pivot bracket 50 may include a flared portion 64 on a top surface and a bottom surface of the second end 56 for force distribution through the pivot bracket 50 as the pivot bracket 50 is moved during actuation.

The bolt-receiving aperture 62 may receive a cogged or toothed gear 66 as best shown in FIGS. 6 and 7. The toothed gear 66 may have any suitable number of teeth or facets and the number of teeth may be pre-selected to cause a predetermined adjustment angle for the pivoting motor arms. In an exemplary embodiment, the toothed gear 66 may have ten teeth. The toothed gear 66 may be configured such that the engagement between the toothed gear 66 and the bolt-receiving aperture 62 provides for an anti-rotation grip between the pivot bracket 50 and the toothed gear 66 grip where the toothed gear 66 is secured for pivoting movement with the pivot bracket 50. The engagement between the toothed gear 66 and the pivot bracket 50 may be adjustable by moving the pivot bracket 50 along the shaft of the toothed gear 66.

The motor arm 28 may include an arm portion 68a that is cylindrical and a bolt portion 68b that is connected to the arm portion 68a. The arm portion 68a and the bolt portion 68b may be formed of aluminum or any other suitable material. The arm portion 68a may define an aperture 68c for receiving the static tube of the propeller. As best shown in FIG. 7, the arm portion 68a and the toothed gear 66 may be formed as an integral component that is engageable with the pivot bracket 50. The motor arm 28 may be a two-piece component that is formed by a water jet cutting process. Using a water jet cutting process to form the pivoting motor arms may be advantageous in that the process may be cost-effective.

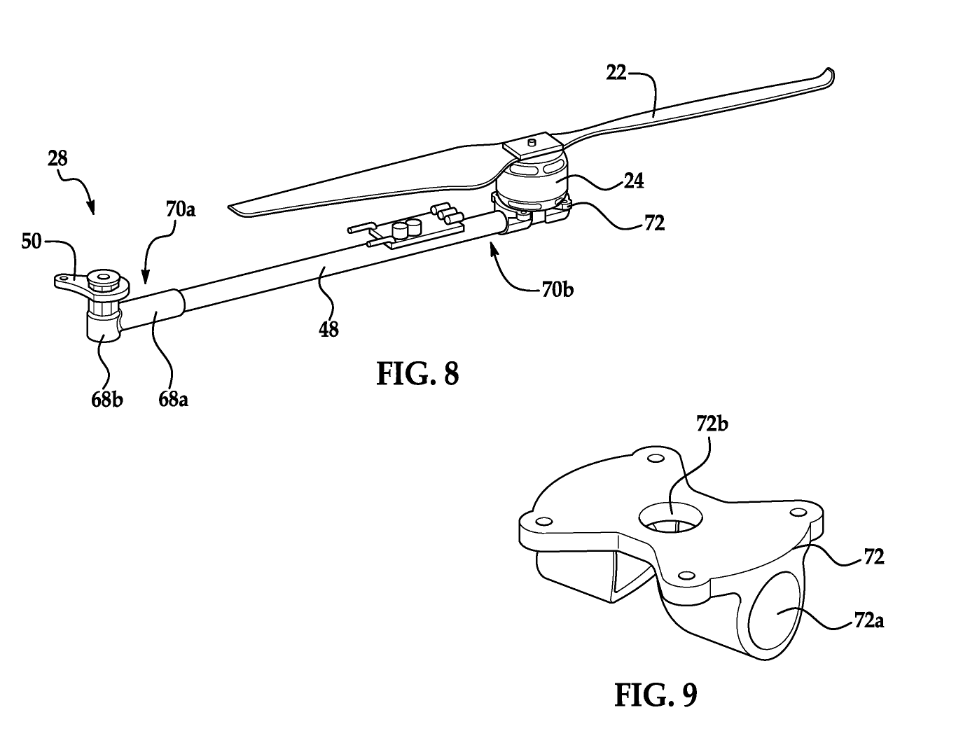

As shown in FIG. 8, the arm portion 68a of the motor arm 28 may receive the static tube 48. The static tube 48 may be formed of carbon fiber and the static tube 48 may extend from a first end 70a to a second end 70b. The motor arm 28 may be secured to the first end 70a of the static tube 48 and a motor mounting bracket 72 may be secured to the second end 70b of the static tube 48. The motor mounting bracket 72 may be attached between the static tube 48 and the motor 24 corresponding to the propeller 22. The motor mounting bracket 72 may enable the multirotor platform to be modular in that different motors may be accommodated by the motor mounting bracket 72. Each motor and propeller may be mounted to the corresponding static tube via a similar motor mounting bracket. As best shown in FIG. 9, the motor mounting bracket 72 may include an axially extending aperture 72a for receiving the static tube 48 and an aperture 72b for receiving a corresponding mounting portion of the motor 24, such that the longitudinal axis of the motor 24 is arranged perpendicularly to the longitudinal axis of the static tube 48. The motor mounting bracket 72 may be formed of any suitable material such as an injection molded plastic.

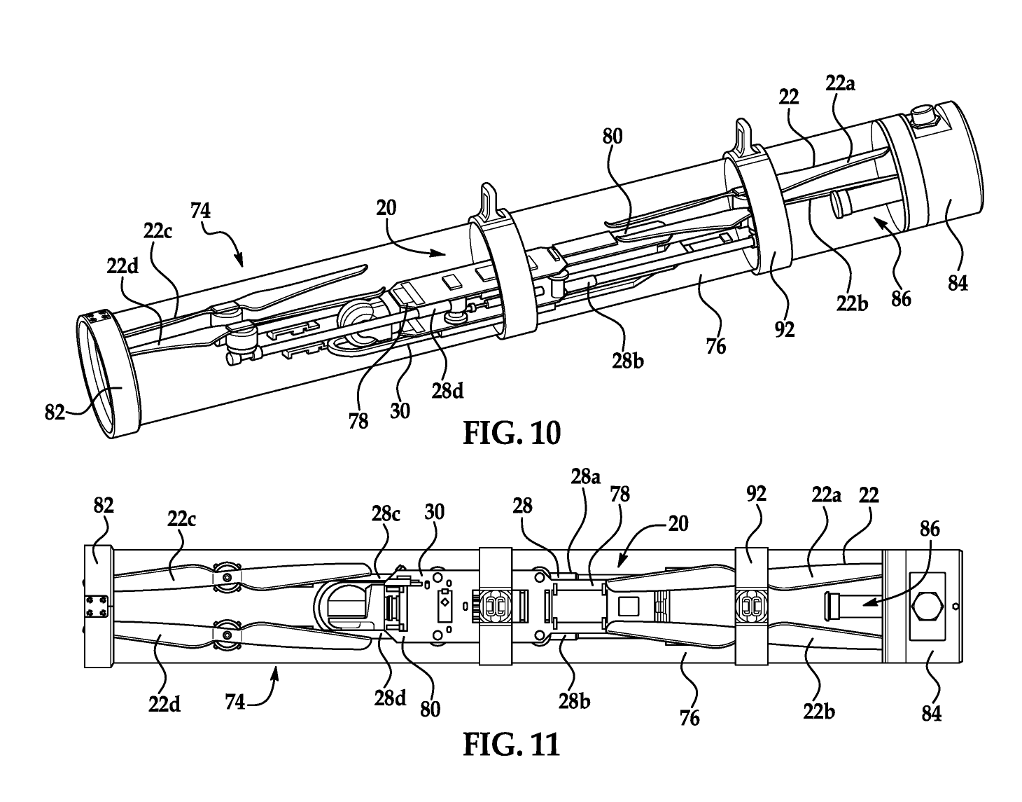

Referring now to FIGS. 10-12, the multirotor platform 20 may be part of a launching system 74. The launching system 74 may be a UAV launching system for launching a multirotor platform 20 that is a UAV. The launching system 74 may include a launch tube 76 having any suitable shape. For example, the launch tube 76 may be rectangular or cylindrical. The launch tube 76 may have a longitudinal axis. When the multirotor platform 20 is in the first position or in the storage state as described above, the multirotor platform 20 may be housed within the launch tube 76. When in the storage state, the at least one propeller 22 or the propellers 22a, 22b, 22c, 22d may extend in a direction that is parallel to the longitudinal axis. The pivoting motor arms 28b, 28d and the propellers 22a, 22b, 22c, 22d may be arranged symmetrically about the main flight body 30. When the multirotor platform 20 is configured as a quadcopter, the multirotor platform 20 may include two propellers 22a, 22b and two corresponding pivoting motor arms 28a, 28b that extend outwardly from a first side end 78 of the main flight body 30. The multirotor platform 20 may further include two propellers 22c, 22d and two corresponding pivoting motor arms 28c, 28d that extend outwardly from a second side end 80 of the main flight body 30, in a direction that is opposite to the direction in which the two propellers 22a, 22b extend. The first side end 78 and the second side end 80 may extend parallel to one another and the side ends may extend between ends of the main flight body 30.

The propellers 22a, 22b, 22c, 22d may extend between a first end 82 and a second end 84 of the launch tube 76 within the launch tube 76 when in the storage state. The second end 84 may be a muzzle end or an open end through which the multirotor platform 20 is ejected or exits the launch tube 76. An actuating device 86 may be arranged at the second end 84 of the launch tube 76. Any suitable actuating device 86 may be used and the actuation may be electric, mechanical, or pneumatic. The actuation may include using a compressed gas, such as a compressed carbon dioxide cartridge for forcing the multirotor platform 20 out of the launch tube 76.

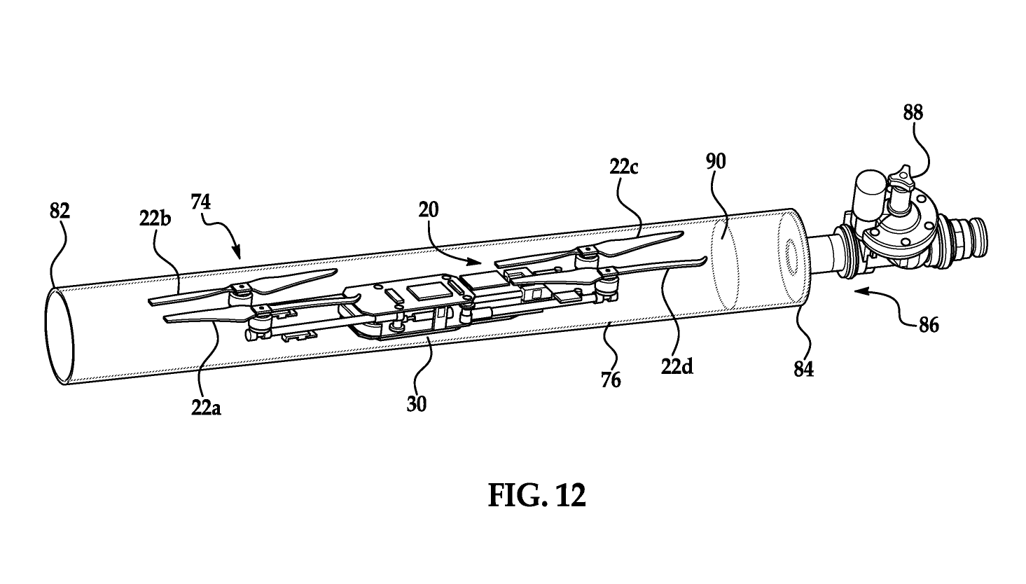

An exemplary actuating device 86 for forcing the multirotor platform 20 out of the launch tube 76 is shown in FIG. 12. The exemplary actuating device 86 may include a suitable valve 88. The actuation device 86 may include a force distribution piston or puck 90 that is arranged within the launch tube 76 at the second end 84 of the launch tube 76. The force distribution puck 90 may distribute a load from the valve 88 to the launch tube 76 for actuating the multirotor platform 20. The force distribution puck 90 may move axially through the launch tube 76 from the second end 84 of the launch tube 76 toward the first end 82 of the launch tube 76. The force distribution puck 90 may be configured to force the multirotor platform 20 towards the first end 82 of the launch tube 76 such that a cover of the launch tube 76 is breached and the multirotor platform 20 may exit the launch tube 76. The launching system 74 may be configured such that the actuation device 86 is actuated to cause an unequal pressure distribution through the launch tube 76 that forces the multirotor platform 20 out of the launch tube 76.

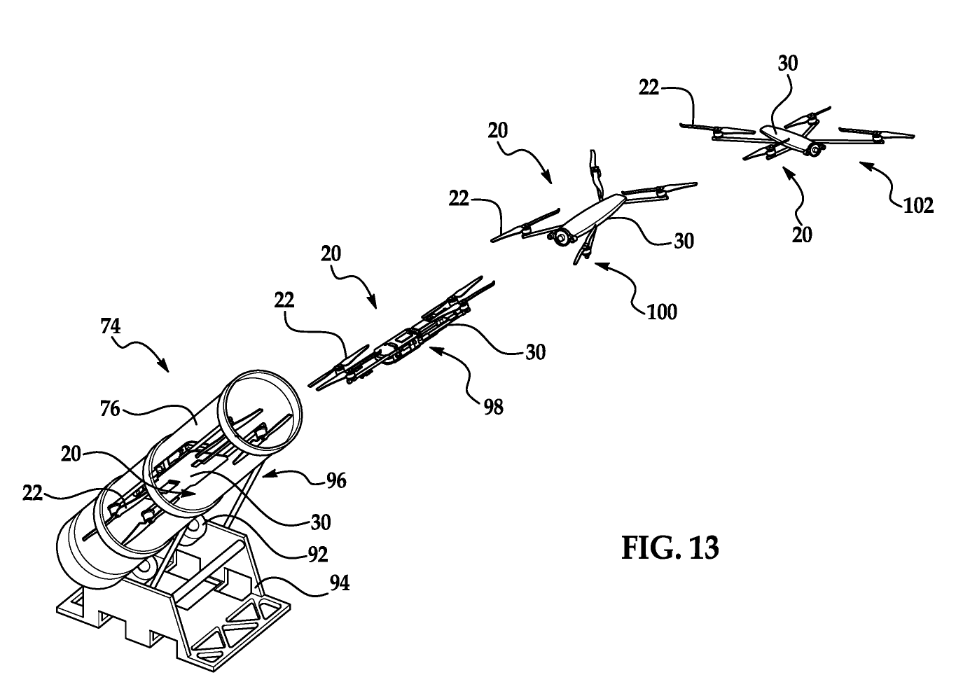

As best shown in FIGS. 10 and 11, the launch tube 76 may further include a plurality of mounting rings 92 that are disposed about the periphery of the launch tube 76. Referring in addition to FIG. 13, the mounting rings 92 may enable the launch tube 76 to be attached to a launching device or system, such as a fixed platform 94. In an exemplary embodiment, the mounting ring 92 may include a lug, such that the launch tube may be supported on a weapons rack. An exemplary ground launch system 74 is shown in FIG. 13. The fixed platform 94 is arranged on a non-moving surface, but the ground launch system 74 may be arranged on a moving platform such as a land vehicle. In operation, the multirotor platform 20 may be in a stowed position 96 where the multirotor platform 20 is arranged within the launch tube 76 and the propellers 22 and the pivoting motor arms are in a retracted or folded position against the main flight body 30 of the multirotor platform 20. When the launch system 74 is actuated, the multirotor platform 20 may be forced or launched out of the launch tube 76 to a muzzle exit position 98. When in the muzzle exit position 98, the propellers 22 may remain in the retracted or folded position before the pivoting motor arms of the multirotor platform 20 are actuated and the multirotor platform 20 is able to transition to the flight state. When in the muzzle exit position 98, the pivoting motor arms that are connected to the motors for driving the propellers 22 may be deployed and the multirotor platform 20 may move from the muzzle exit position 98 to a motor deployment position 100. After the pivoting motor arms, motors, and propellers 22 have been deployed, the propellers 22 may be driven by the motors and the multirotor platform 20 may be in a flight state 102. Using the deployable pivoting motor arms and motors enables self-propulsion of the multirotor platform 20 such that the multirotor platform 20 may be launched from a storage position within the launch tube 76 and directly transition to flight.

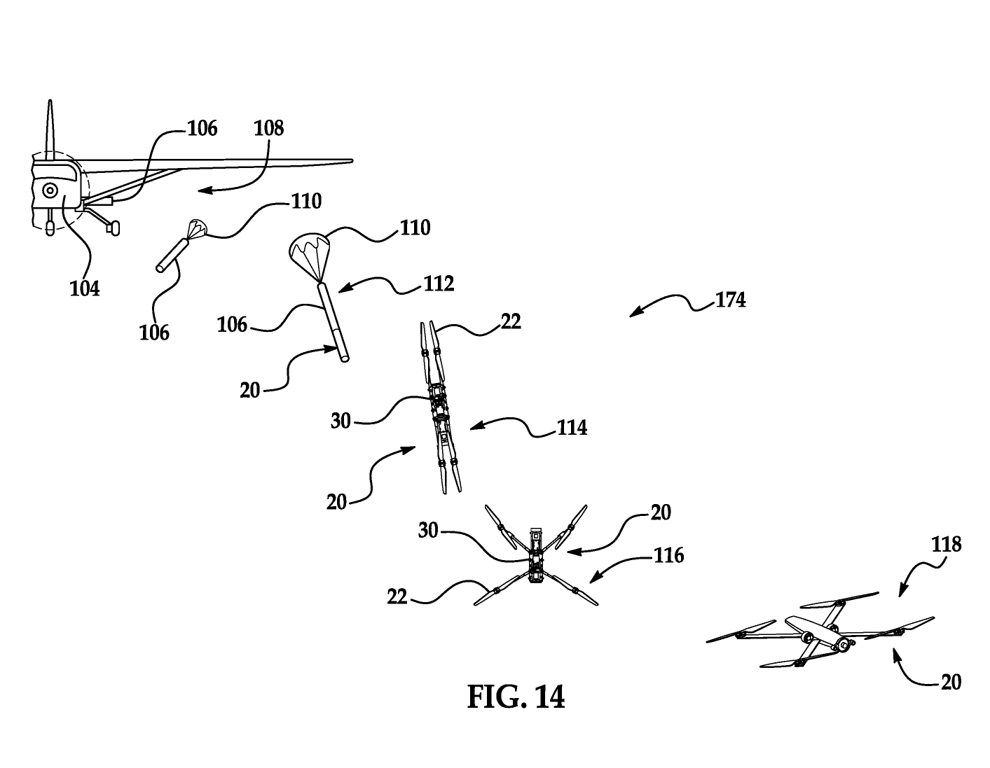

Referring now to FIG. 14, a second exemplary launch system 174 is shown where the multirotor platform 20 is launched from any suitable flight vehicle or aircraft 104. The aircraft 104 may include a sabot 106 that is ejected from the aircraft 104 into an ejected position 108, where the sabot 106 is carried by a chute 110. The sabot 106 may be attached to the multirotor platform 20. When in the ejected position 108, the multirotor platform 20 may be actuated and the multirotor platform 20 may be released or detached from the sabot 106 to a deployment position 112. The sabot 106 may fall independently from the multirotor platform 20. The multirotor platform 20 may be any suitable UAV that is capable of flight independently of the flight of the aircraft 104. When the multirotor platform 20 is released from the sabot 106, the multirotor platform 20 may initially remain in a stowed position 114 where the propellers 22 are in the retracted or folded position and extend parallel relative to the main flight body 30. The pivoting motor arms that are connected to the motors for driving the propellers 22 may then be actuated and the multirotor platform 20 may move from the stowed position 114 to a motor deployment position 116. After the pivoting motor arms, motors, and propellers 22 have been deployed, the multirotor platform 20 may stabilize such that the multirotor platform 20 may move the main flight body 30 from a vertical position to a horizontal position. After the multirotor platform 20 is stabilized, the multirotor platform 20 may transition to a flight position 118 where the multirotor platform 20 is in a flight state. Using the deployable pivoting motor arms and motors enables self-propulsion of the multirotor platform 20 such that the multirotor platform 20 may be directly launched from a moving platform, such as a flight vehicle, and transition to flight.

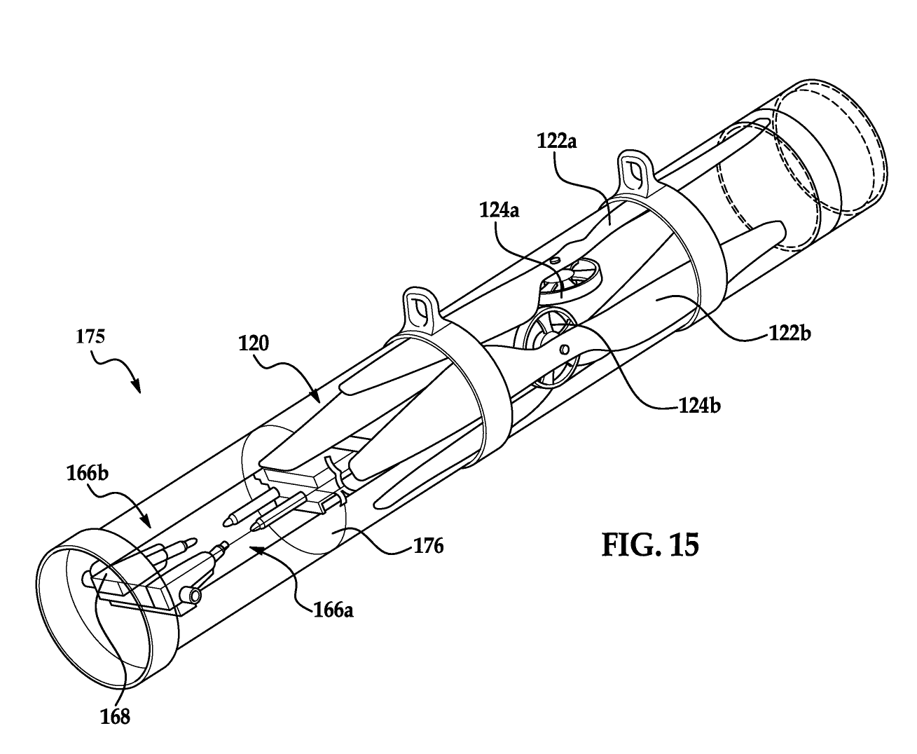

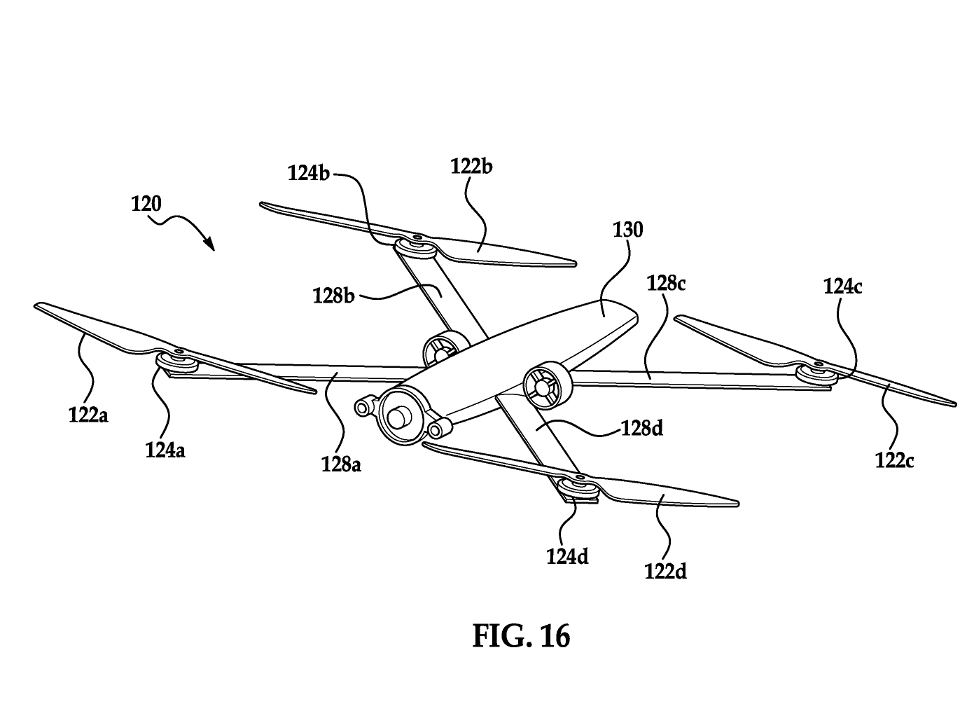

Referring now to FIGS. 15 and 16, a second exemplary embodiment of a multirotor platform 120 is shown. FIG. 15 shows another exemplary embodiment of a launching system 175, where the multirotor platform 120 is in a first position. When the multirotor platform 120 is in the first position, the multirotor platform 120 may be in a storage or stowed position within a launch tube 176. FIG. 16 shows the multirotor platform 120 in a second position, which may be a deployed position or a flight state of the multirotor platform 120. As best shown in FIG. 16, the multirotor platform may include a plurality of propellers 122a, 122b, 122c, 122d, a plurality of motors 124a, 124b, 124c, 124d, and a plurality of motor pylon wings 128a, 128b, 128c, 128d connected between the main flight body 130 and the motors 124a, 124b, 124c, 124d. The motor pylon wings 128a, 128b, 128c, 128d may be control surfaces used to control flight of the multirotor platform 120. The motors 124a, 124b, 124c, 124d may be cylindrical in shape. When in the storage position of FIG. 15, the motors 124a, 124b, 124c, 124d may be positioned such that the diameters of the motors extend in a direction that is perpendicular to a longitudinal axis of the launch tube 176. The motors may be arranged vertically or horizontally within the launch tube 176 to minimize the amount of space that the multirotor platform 120 accommodates when in the storage position within the launch tube 176. For example, at least one motor 124a may be arranged horizontally and at least one motor 124b may be arranged vertically.

When in the storage position, the motor pylon wings 128a, 128b, 128c, 128d may be in a folded or a retracted position such that the motor pylon wings 128a, 128b, 128c, 128d and the propellers 122a, 122b, 122c, 122d may extend in the direction of the longitudinal axis of the launch tube 176 and along the main flight body 30. When in the storage position, the propellers 122a, 122b, 122c, 122d may be constrained from rotation. After transitioning to the flight state, the motor pylon wings 128a, 128b, 128c, 128d and the propellers 122a, 122b, 122c, 122d may extend outwardly from the main flight body 130 of the multirotor platform 120 such that the propellers 122a, 122b, 122c, 122d are able to rotate.

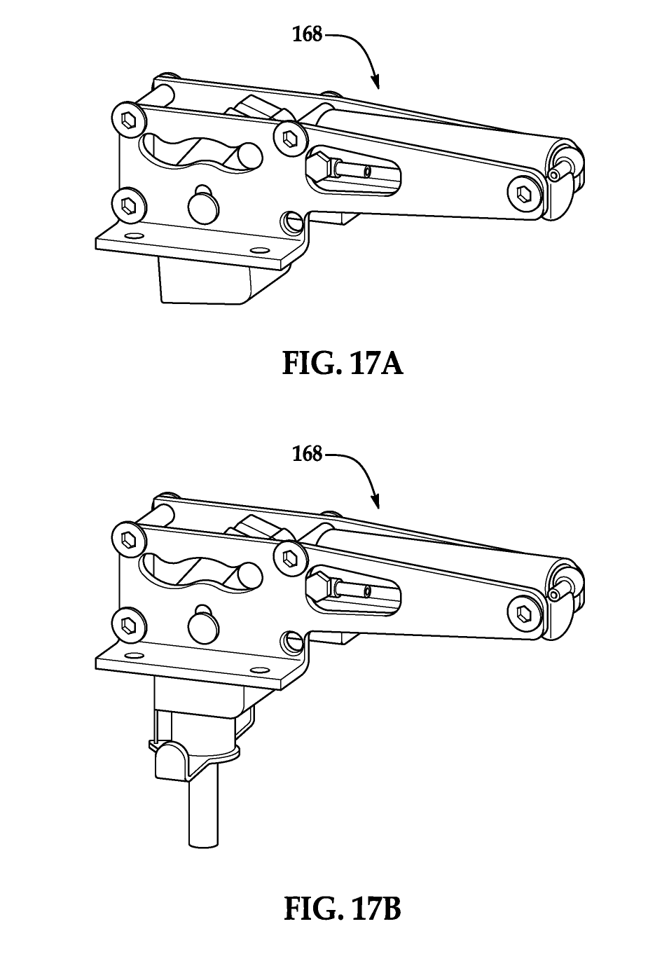

The launching system 174 may include a plurality of retracts 166a, 166b that are connected to the plurality of motors 124a, 124b, 124c, 124d for swinging the motor pylon wings 128a, 128b, 128c, 128d and the motors 124a, 124b, 124c, 124d outwardly from the main flight body 130. Each of the motor pylon wings 128a, 128b, 128c, 128d may correspond to one of the plurality of retracts. Each of the retracts 166a, 166b may include any suitable retractable gear, such as a retractable landing gear. The retracts 166a, 166b may be actuated electrically, mechanically, or pneumatically, and the retracts 166a, 166b may be rotatable 90 degrees for moving the motor pylon wings 128a, 128b, 128c, 128d among different storage positions and flight positions. The retracts 166a, 166b may be remote controllable. Each of the retracts 166a, 166b may include a nose gear 168 that is moveable from a retracted position shown in FIG. 17A to an extended position shown in FIG. 17B. The nose gear 168 may be pivotable to steer the corresponding motor pylon wing such that the nose gears may be used to fly the motor pylon wings 128a, 128b, 128c, 128d. The nose gear 168 may be retracted and extended via any suitable actuator. For example, the actuator may be a hydraulic cylinder with a piston rod or a servo-type actuator. Using the retracts 166a, 166b and the airfoils of the pylon wings 128a, 128b, 128c, 128d may enable the multirotor platform 120 to be deployed from an aircraft and have unpowered flying movement or gliding movement, as compared with the above described multirotor that may be configured to make a powered flight. The gliding multirotor platform 120 may be capable of intelligence, surveillance, and reconnaissance, or any other suitable functions. Using the nose gears and the motor pylon wings may enable the gliding multirotor platform 120 to glide from the air to the ground without wasting electrical power.

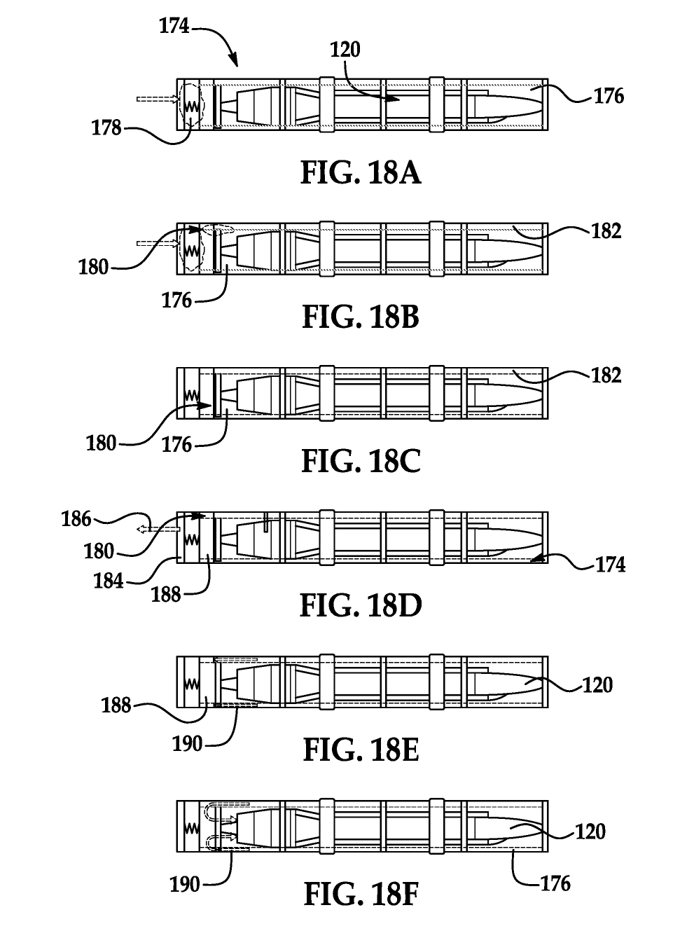

Referring now to FIGS. 18A-F, the operation of an exemplary launching system 174 for launching the multirotor platform 120 from the launch tube 176 is shown. Pneumatic actuation of the exemplary launching system 174 is shown in FIGS. 18A-F, but any suitable actuation may be used. The multirotor platform 120 may be launched from the launch tube 176 in the storage position before the motors and propellers are deployed for flight or gliding movement. FIG. 18A shows that compressed air may be released into a first chamber 178 of the launch tube 176. Releasing the compressed air into the launch tube 176 may be automated or electrically controlled. FIG. 18B shows that the compressed air may bleed through a leak hole 180 into a reservoir 182 of the launch tube 176. FIG. 18C shows that the reservoir 182 may be pressurized such that the launching system 174 is in equilibrium. When the launching system 174 is in equilibrium, FIG. 18D shows that a dump valve 184 may be opened to allow the pressure 186 to escape from a first side of a piston 188 at a greater speed than through the leak hole 180 such that the launching system 174 may be unbalanced and a higher pressure is exerted against the piston 188. The higher pressure 190 is exerted against the piston 186 as shown in FIG. 18E. The high pressure 190 may then be dumped into the launch tube 176 to force the multirotor platform 120 out of the launch tube 176 as shown in FIG. 18F.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (external components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A multirotor platform having a storage state and a flight state, the multirotor platform comprising:
a main flight body having an energy source;
a plurality of propellers and motors for driving the propellers, the motors being powered by the energy source and the propellers being moveable relative to the main flight body;
a plurality of pivoting motor arms that are connected between the propellers and the main flight body, wherein the pivoting motor arms are in a retracted position during the storage state and are moveable to an extended position when the multirotor platform transitions from the storage state to the flight state, the pivoting motor arms extending along the main flight body when in the retracted position; and
an actuator for pivoting the motor arms away from the main flight body when moving to or from the retracted position.

2. The multirotor platform of claim 1, wherein the pivoting motor arms are symmetrically arranged about the main flight body.

3. The multirotor platform of claim 1, wherein the main flight body extends along a central axis, wherein during the storage state, the motor arms extend in a direction that is parallel to the central axis, and wherein during the flight state, the motor arms extend in a direction that is oblique or perpendicular to the central axis of the main flight body.

4. The multirotor platform of claim 1, wherein each of the motor arms includes a cogged shaft having ends that are secured to the main flight body, the cogged shaft being rotatable about a central axis of the cogged shaft for pivoting the motor arms.

5. The multirotor platform of claim 4, wherein each of the motor arms includes a cogged arm that is perpendicularly fixed to the cogged shaft, the cogged arm being pivotable about the central axis.

6. The multirotor platform of claim 5, wherein each of the motor arms includes a bolt arranged on the cogged shaft, the bolt being pivotable to rotate the cogged shaft and pivot the cogged arm.

7. The multirotor platform of claim 1 further comprising a plurality of static tubes secured between the motor arms and the motors, wherein the motors may be moveable relative to the main flight body.

8. The multirotor platform of claim 1, wherein the actuator includes a plurality of sources of compressed gas that are each associated with a corresponding one of the motor arms for pivoting the motor arms.

9. The multirotor platform of claim 1, wherein the actuator includes a plurality of pre-loaded springs that are each connected to a corresponding one of the motor arms.

10. The multirotor platform of claim 1, wherein the multirotor platform is self-propelled for transitioning directly from the storage state to the flight state.

11. The multirotor platform of claim 1, wherein the multirotor platform includes at least three motor arms.

12. The multirotor platform of claim 11, wherein the multirotor platform is a quadcopter having at least four motor arms.

13. The multirotor platform of claim 1, wherein each of the motor arms includes a pylon and a nose gear for controlling the pylon after the pylon has moved to the extended position.

14. The multirotor platform of claim 13, wherein the pylon is a control surface for the multirotor platform and the multirotor platform has unpowered gliding movement during the flight state.

15. An unmanned aerial vehicle launching system comprising:
a launch tube having a longitudinal axis;
a multirotor platform that is housed within the launch tube during a storage state and launched from the launch tube to transition to a flight state, the multirotor platform comprising:
a main flight body having an energy source;
a plurality of propellers and motors for driving the propellers, the motors being powered by the energy source and the propellers being moveable relative to the main flight body; and
a plurality of pivoting motor arms connected between the main flight body and the plurality of motors, wherein the plurality of pivoting motor arms are in a retracted position during the storage state and are moveable from the retracted position to an extended position after the multirotor platform exits the launch tube, the propellers being constrained from movement when the motor arms are in the retracted position;
at least one actuator for forcing the multirotor platform out of the launch tube and pivoting the motor arms, the multirotor platform being in the flight state after the motor arms are actuated and the propellers are unconstrained from movement.

16. The unmanned aerial vehicle launching system of claim 15, wherein the pivoting motor arms are symmetrically arranged around the main flight body and wherein during the storage state, the pivoting motor arms extend in a direction that is parallel to the longitudinal axis of the launch tube.

17. The unmanned aerial vehicle launching system of claim 15, wherein the main flight body extends along a central axis, and wherein during the flight state, the pivoting motor arms extend in a direction that is oblique or perpendicular to the central axis of the main flight body.

18. The unmanned aerial vehicle launching system of claim 15, wherein each of the pivoting motor arms includes a rotatable cogged shaft having ends that are secured to the main flight body, a cogged arm that is perpendicularly fixed to the cogged shaft, and a bolt arranged on the cogged shaft, wherein the bolt is pivotable to rotate the cogged shaft and pivot the cogged arm about a rotation axis of the cogged shaft.

19. The unmanned aerial vehicle launching system of claim 15, wherein the at least one actuator includes at least one of a source of compressed gas and a pre-loaded spring associated with each of the pivoting motor arms.

20. A method for launching a multirotor platform comprising:
storing the multirotor platform in a launch tube having a longitudinal axis, wherein the multirotor includes a main flight body having an energy source, a plurality of propellers, and a plurality of motors for driving the propellers, the motors being powered by the energy source;
folding a plurality of pivoting motor arms that are connected between the main flight body and the plurality of propellers against the main flight body, the plurality of propellers being constrained from movement, the plurality of pivoting motor arms extending in a direction parallel to the longitudinal axis of the launch tube;
actuating the multirotor platform to force the multirotor platform out of the launch tube;
actuating the plurality of pivoting motor arms to pivot outwardly from the main flight body and move the plurality of propellers to an unconstrained position;
driving the plurality of propellers using the plurality of motors to fly the multirotor platform.
